(19) United States
(12) Patent Application Publication
(10) Pub. No.: US 2024/0198263 A1
(43) Pub. Date: Jun. 20, 2024

(54) DEVICE AND METHOD FOR SEPARATING LIQUID DROPLETS FROM A GAS STREAM BY MEANS OF A CENTRIFUGAL MIST ELIMINATOR

(71) Applicant: BASF SE, Ludwigshafen am Rhein (DE)

(72) Inventors: Yunfei ZHOU, Ludwigshafen am Rhein (DE); Ortmund LANG, Ludwigshafen am Rhein (DE); Matthias Wilhelm MEIER, Ludwigshafen am Rhein (DE); Cornelis Hendricus DE RUITER, Ludwigshafen am Rhein (DE); Marvin KRAMP, Ludwigshafen am Rhein (DE); Gregor GRACKIEWICZ, Ludwigshafen am Rhein (DE); Josef MACHT, Ludwigshafen am Rhein (DE); Markus GITTER, Ludwigshafen am Rhein (DE); Claus HECHLER, Ludwigshafen am Rhein (DE)

(21) Appl. No.: 18/288,043

(22) PCT Filed: Apr. 19, 2022
(86) PCT No.: PCT/EP2022/060253

§ 371 Date: Oct. 24, 2023

(30) Foreign Application Priority Data
Apr. 26, 2021 (EP) 21170447.3

(51) Int. Cl. B01D 45/16; B01D 47/06

(52) U.S. Cl. CPC B01D 45/16; B01D 47/06

(57) ABSTRACT

The invention relates to a centrifugal droplet separator for separating liquid droplets out of a gas stream, comprising a shell (1) having a circular cross section and a vertical longitudinal axis (11), an upper hood (2) that bounds the shell (1) at the top and has a gas exit port (7) for the gas stream cleaned in the centrifugal droplet separator, a drip plate (8) disposed beneath the gas exit port (7), a lower hood (10) that bounds the shell (1) at the bottom and has a liquid exit port (4) for removal of the deposited liquid droplets, and an inlet (3) that opens tangentially into the shell (1) for supply of the gas stream,
wherein
there are at least two nozzles (9) for feeding a stabilizer liquid into the interior of the centrifugal droplet separator, the respective nozzle outlet (15) of which is disposed between the tangential inlet (3) and the drip plate (8) in vertical direction, where the main spraying direction (12) of the nozzles (9) is directed upward at an internal angle of 0 to 60° relative to the vertical longitudinal axis (11).

The invention additionally also relates to a method of separating liquid droplets out of a gas stream in such a centrifugal droplet separator.

The invention relates to a centrifugal droplet separator for separating liquid droplets out of a gas stream, comprising a shell having a circular cross section and a vertical longitudinal axis, an upper hood that bounds the shell at the top and has a gas exit port for the gas stream cleaned in the centrifugal droplet separator, a drip plate disposed beneath the gas exit port, a lower hood that bounds the shell at the bottom and has a liquid exit port for removal of the deposited liquid droplets, and an inlet that opens tangentially into the shell for supply of the gas stream.

The invention additionally also relates to a method of separating liquid droplets out of a gas stream in such a centrifugal droplet separator.

In processes for producing acrylates that result from acid-catalyzed esterification of (meth)acrylic acid with C4 to C10 alcohols, it is customary to use high-boiling process stabilizers, e.g. phenothiazine (PTZ), or else liquid solutions or liquid mixtures comprising process stabilizers. These process stabilizers have to be separated in the acrylate vapor that results from the process to assure the quality of the product. These acrylate methods also can be used to produce, depending on the alcohol used, acrylates including n-butyl acrylate (nBA), 2-ethylhexyl acrylate (2-EHA), isobutyl acrylate, 2-propylheptyl acrylate or octyl acrylate.

In such processes, it is customary to use a droplet separator, for example lamellar separators or demisters, which are also known as separators with a wire knit. However, these droplet separators are prone to soiling or polymer formation, caused by liquid droplets present in the gas stream.

Thus, the liquid droplets that occur block the pores of the lamellas or of the wire knit over time. In that case, the plant has to be shut down, in order to enable cleaning or exchange. Problems of this kind are described, for example, in document DE 19604253 A1 (BASF AG), which discloses a 2-ethylhexyl acrylate (2-EHA) production process using a demister. As a further example, document DE 10063510 A1 (BASF AG) discloses a process for producing n-butyl acrylate (nBA), which likewise separates out the liquid droplets using a demister.

In this context, the components present in the liquid droplets are defined by the specific process. For example, the liquid droplets include high boiler components that originate from the reactor, for example, or the actual product of value, for example the nBA or the 2-EHA.

A known alternative to a separate droplet separator is a climbing film evaporator (Ralf Goedecke, “Grundlagen, Methodik, Technik, Praxis” [Basics, Methodology, Technology, Practical Use], Fluidverfahrenstechnik [Fluid Engineering], WILEY-VCH Verlag, Weinheim, 2006) in which there is an integrated a droplet separator in the upper region of the climbing film evaporator.

A centrifugal droplet separator does not need a porous structure, like a demister for example. Therefore, a centrifugal droplet separator is less prone to blockage by polymers and impurities by comparison with the above-described wire knit. Therefore, a longer plant run time, a saving on maintenance costs and an increase in production rates can be expected.

Also disclosed in the prior art are general separators that exploit centrifugal forces for deposition of solid or liquid particles. Document EP 2 076 335 B1 (Vortex Ecological Technologies Ltd) describes how impurities can be removed from flue gases. A further separator is disclosed, for example, in document DE 2137128 A1 (Siemens AG), in which solid or liquid particles are removed from a crude gas.

However, this type of separator does not separate out liquid droplets or serves merely for the purpose of processing a crude gas. Moreover, these separators are not used for chemical processes that produce polymers as target product.

In general, a centrifugal droplet separator affords a comparable separation performance to a wire knit. Small droplets are separated out of the vapor for the most part in the separator.

The disadvantage of centrifugal droplet separators is that the use thereof in a chemical method can frequently result in polymer formation on the walls of the centrifugal droplet separator. As a result, cleaning is often required. Typically, a spray device is used for the purpose. This wets the walls with a liquid, in order thus to be able to guarantee the function of the centrifugal droplet separator over a certain period of time.

Disclosure EP 2512683 B1 (BASF SE) teaches spraying a purge liquid into a centrifugal droplet separator, in which spraying tangentially and in the circumferential direction relative to the wall of a gas exit port is described.

The disadvantage of this process is that polymer formation on the walls of the centrifugal droplet separator or on the walls of internals cannot be prevented by the purging in many applications or under certain operating conditions. The deposits resulting from the polymer formation disrupt the function of the centrifugal droplet separator.

As a result, such centrifugal droplet separators in the corresponding methods also have to be regularly maintained and cleaned.

The problem addressed was that of providing a centrifugal droplet separator for chemical processes, on the wall surfaces of which and on the wall surfaces of the internals of which no polymer formation by liquid droplets takes place during operation, or polymer formation is at least reduced significantly during operation, such that fewer maintenance intervals are obtained. In this context, even during operation, it should be possible to efficiently separate the small liquid droplets out of the gas stream.

A further problem addressed was that of providing such a centrifugal droplet separator that can be used in chemical processes for preparing n-butyl acrylate (nBA) or 2-ethylhexyl acrylate (2-EHA) in particular, and is of particularly good suitability for the purpose.

These problems have been solved in accordance with the invention by a centrifugal droplet sep-arator according to claim 1 and by a method of separating liquid droplets out of a gas stream according to claim 10. Advantageous configurations of the centrifugal droplet separator of the invention are specified in claims 2 to 9. Advantageous configurations of the method of the invention are specified in claims 11 to 14.

The centrifugal droplet separator of the invention for separating liquid droplets out of a gas stream comprises a shell having a circular cross section and a vertical longitudinal axis, an upper hood that bounds the shell at the top and has a gas exit port for the gas stream cleaned in the centrifugal droplet separator, a drip plate disposed beneath the gas exit port, a lower hood that bounds the shell at the bottom and has a liquid exit port for removal of the deposited liquid droplets, and an inlet that opens tangentially into the shell for supply of the gas stream. According to the invention, there are at least two nozzles for feeding a stabilizer liquid into the interior of the centrifugal droplet separator, the nozzle outlet of the respective nozzle is above the tangential inlet and below the drip plate in the centrifugal droplet separator, and the main spraying direction for each individual nozzle is directed upward at an internal angle in the range from 0 to 60° relative to the vertical longitudinal axis, as a result of which all walls in the interior of the centrifugal droplet separator are fully wettable.

By virtue of the direction of gravity, stabilizer liquid that has been sprayed in the direction of the upper hood flows downward and hence also wets the other surface regions of the centrifugal droplet separator. The surfaces of internals within the spray jet of the nozzles are likewise correspondingly also wetted. It is thus possible for the inventive arrangement to effectively prevent polymer formation on the surfaces of the centrifugal droplet separator and its internals.

The inventive arrangement of the nozzles below the drip plate makes it possible to sufficiently wet all wall surfaces of the shell and internals of the centrifugal droplet separator with stabilizer liquid. Even in the case of dead zones that are also known to the person skilled in the art as backflow areas, it is possible to wet the wall surfaces, for example, in the edge regions of the upper centrifugal droplet separator region. Internals in the centrifugal droplet separator are also wetted completely and sufficiently on the outside, for example the drip plate.

The gas stream is surprisingly not significantly disrupted by the spraying in the opposite direction to gravity, such that this method of the invention does not significantly reduce the separation performance of the centrifugal droplet separator.

In a preferred configuration of the centrifugal droplet separator, the length ratio between the axial distance of the nozzle outlet of the uppermost nozzle from the drip plate and the height of the centrifugal droplet separator is in the range from 0.03 to 0.15. Thus, given a customary height of the centrifugal droplet separator in the range from 1 to 10 m, a suitable distance from the drip plate is assured, which means that the drip plate can be wetted sufficiently with the stabilizer liquid using conventional nozzles.

In a further preferred configuration of the centrifugal droplet separator, the length ratio between the radial distance of the nozzle outlet from the inner shell surface and the height of the centrifugal droplet separator is not more than 0.06. Thus, spraying-in of the stabilizer liquid close to the wall is assured, which means that the impact of the stabilizer liquid on the shell surface is at a sufficiently obtuse angle and hence only a small amount of stabilizer liquid splashes back off the shell surface.

In a preferred configuration of the centrifugal droplet separator, the internal angle of the respective nozzle is in the range from 0 to 50°, more preferably in the range from 0 to 40° and most preferably in the range from 0 to 30°.

In a further preferred configuration of the centrifugal droplet separator, the respective main spraying directions of the nozzles are inclined away from the shell.

In a further preferred configuration of the centrifugal droplet separator, an open apex cone for stabilization of the gas stream is mounted on baffles in the liquid exit port.

In a further preferred configuration of the centrifugal droplet separator, the gas exit port in the centrifugal droplet separator is at least partly above the shell on the side of the outer face of the shell. As a result, further-reduced polymer formation or none can take place at the gas exit port, since fewer dead zones are provided in that case.

In a preferred configuration, the lower half of the centrifugal droplet separator has a temperature control device on the outside of the shell. The temperature control device is preferably a heater. The heating of the shell can further reduce polymer formation in suitable chemical processes.

In a preferred configuration of the centrifugal droplet separator, the nozzles are fixed in the centrifugal droplet separator by at least one insert element, where the respective insert element has a lance and at least one holding element for at least one nozzle. The insert element allows the nozzles to be introduced into the separator and also removed again if required.

In a further configuration of the centrifugal droplet separator, at least one nozzle in each case runs through an opening element in the shell, preferably through a port, where the opening element is sealed by an openable holding element, preferably a flange. The port and flange can be acquired easily and at low cost.

In a further configuration of the centrifugal droplet separator, at least one sealing element, preferably a rubber ring, is provided, which seals the opening elements. Leakage of the gas stream through an elastic element is thus reliably prevented.

In a further configuration of the centrifugal droplet separator, the lower and upper hoods are implemented by the mounting of one flange each at the upper and lower ends of the centrifugal droplet separator. In this way, standard and readily available components are used.

The method of the invention for separating liquid droplets out of a gas stream is conducted in a centrifugal droplet separator comprising a shell having a circular cross section and a vertical longitudinal axis, an upper hood that bounds the shell at the top and has a gas exit port for the gas stream cleaned in the centrifugal droplet separator, a drip plate disposed beneath the gas exit port, a lower hood that bounds the shell at the bottom and has a liquid exit port for removal of the deposited liquid droplets, and an inlet that opens tangentially into the shell, through which the gas stream is fed in. According to the invention, a stabilizer liquid is fed into the interior of the centrifugal droplet separator through at least two nozzles, the nozzle outlet of the respective nozzle is above the tangential inlet and below the drip plate in the centrifugal droplet separator, and the main spraying direction of the respective nozzle is directed upward at an internal angle in the range from 0 to 60° relative to the vertical longitudinal axis, as a result of which all walls in the interior of the centrifugal droplet separator are fully wetted by the stabilizer liquid.

In general terms, a stabilizer is a substance that generally prevents the polymerization of chemical compounds. In particular, a suitable stabilizer reduces the polymerization of chemical compounds within the 2-EHA process or the nBA process.

In a preferred embodiment of the process, the stabilizer liquid is fed continuously to the centrifugal droplet separator. Nearly uniform wetting of the walls is thus ensured.

In a preferred configuration of the method of the invention, the stabilizer liquid comprises 4-methoxyphenol (MeHQ). In this context, polymer formation on the walls is prevented with very particular efficiency without any adverse effect on the subsequent quality of the target product. This is particularly true in the case of acrylate-containing substances.

Further preferred stabilizers that may be present in the stabilizer liquid are, for example, 2,4-dimethyl-6-tert-butylphenol (Topanol A), hydroquinone and/or butylhydroxytoluene (2,6-di-tert-butyl-p-cresol). In principle, any number of stabilizers may be present in the stabilizer liquid in the form of a mixture.

The stabilizer liquid preferably comprises not only the stabilizer(s) but also the target product which is obtained from the process. In this document, the target product is the gas stream exiting from the centrifugal droplet separator. No impurities are added to the process in the case of such stabilizer liquids. In this context, the target product may also appropriately serve as solvent and/or diluent for the stabilizer(s).

In a preferred configuration of the method, the stabilizer liquid is provided to the nozzles by branching off a substream of the target product, collecting it in a batch vessel, mixing it with the stabilizer(s) therein, and then feeding it to the nozzles.

In a further preferred configuration of the method, the gas stream supplied comprises droplets of substances which, because of their chemical properties, have a tendency to polymerize on walls of the centrifugal droplet separator. Complete and sufficient wetting of the shell of the centrifugal droplet separator and of the internals in the centrifugal droplet separator prevent polymer formation on the walls and hence extend the maintenance intervals of the centrifugal droplet separator.

In a very particularly preferred configuration, the gas stream supplied to the centrifugal droplet separator comprises acrylates that have arisen from acid-catalyzed esterification of (meth)acrylic acid with C4 to C10 alcohols, especially n-butyl acrylate by esterification of acrylic acid with n-butanol, or 2-ethylhexyl acrylate by esterification of acrylic acid with 2-ethylhexanol. In these methods, there are typically also small amounts of unwanted components present by virtue of the process, for example phenothiazine (PTZ). These unwanted components are present mainly in the liquid droplets present in the gas stream and are supposed to be deposited in the centrifugal droplet separator in order that the target product maintains its quality. In addition, the liquid droplets comprise further components that preferably arise from the target product inter alia.

In a preferred configuration of the method, the centrifugal droplet separator is designed such that the length ratio between the axial distance of the nozzle outlet of the uppermost nozzle from the drip plate and the height of the centrifugal droplet separator is in the range from 0.03 to 0.15.

In a preferred configuration of the method, the centrifugal droplet separator is designed such that the length ratio between the radial distance of the nozzle outlet from the inner shell surface and the height of the centrifugal droplet separator is not more than 0.06.

In a preferred configuration of the method, the centrifugal droplet separator is designed such that the internal angle of the respective nozzle is in the range from 0 to 50°, preferably in the range from 0 to 40° and more preferably in the range from 0 to 30°.

In a preferred configuration of the method, the centrifugal droplet separator is designed such that an open apex cone for stabilization of the gas stream is mounted on baffles in the liquid exit port.

In a preferred configuration of the method, the centrifugal droplet separator is designed such that the gas exit port in the centrifugal droplet separator is at least partly above the shell on the side of the outer face of the shell.

In a preferred configuration of the method, the centrifugal droplet separator is designed such that the lower half of the centrifugal droplet separator has a temperature control unit, especially a heater, on the outside of the shell.

In a preferred configuration of the method, the centrifugal droplet separator is designed such that the nozzles are fixed in the centrifugal droplet separator by at least one insert element, where the respective insert element has a lance and at least one holding element for at least one nozzle.

In a preferred configuration of the method, the centrifugal droplet separator is designed such that at least one nozzle in each case runs through an opening element in the shell, preferably through a port, where the opening element is sealed by an openable holding element, preferably a flange.

The invention will be elucidated in detail hereinafter with reference to the drawings. The drawings should be considered to be schematic diagrams. They do not constitute a limitation of the invention, for example with regard to specific dimensions or design variants. The figures show:

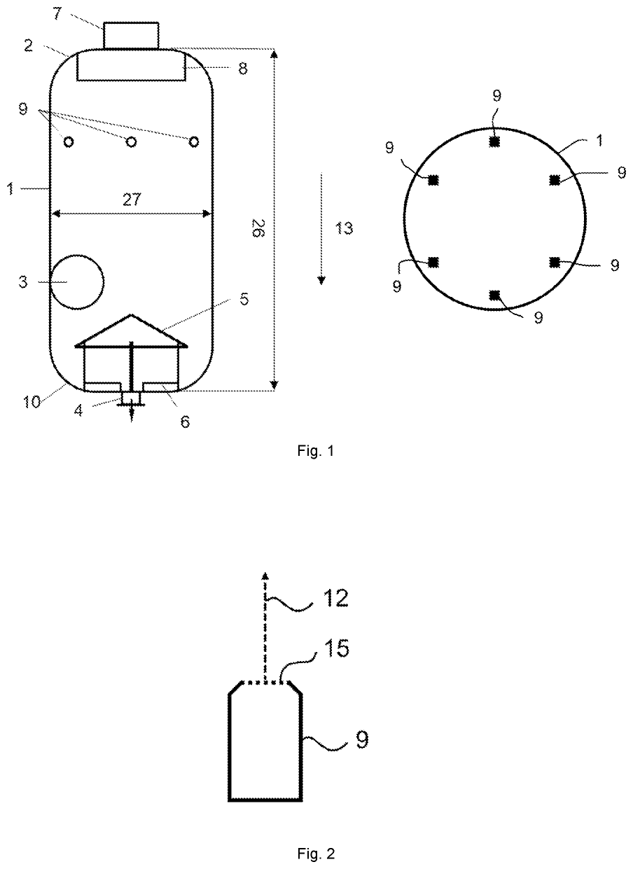

FIG. 1: An example of an embodiment of a centrifugal droplet separator of the invention in longitudinal and transverse section.

FIG. 2: The main spraying direction of the nozzle, which is normal to the nozzle outlet.

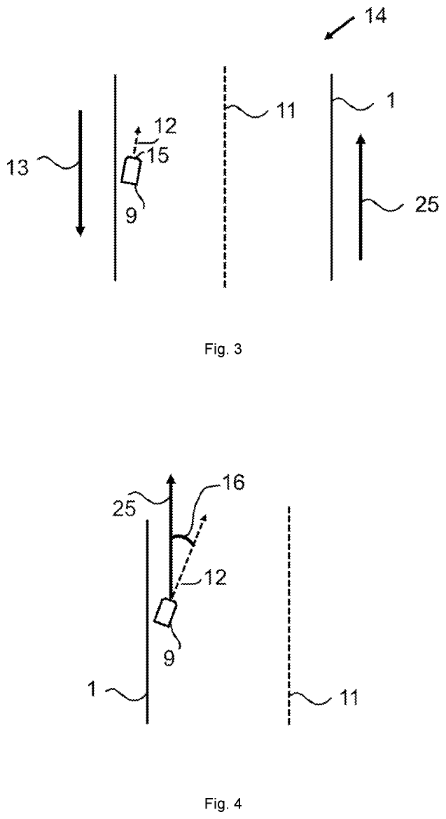

FIG. 3: Section plane determined for a nozzle.

FIG. 4: Internal angle between the main spraying direction of the nozzle and the opposing gravity vector. In this case, the nozzle is inclined away from the shell surface.

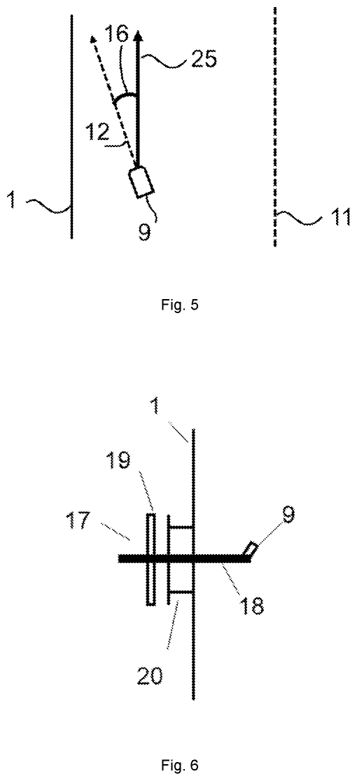

FIG. 5: Internal angle between the main spraying direction of the nozzle and the opposing gravity vector. In this case, the nozzle is inclined toward the shell surface.

FIG. 6: Insert element for the respective nozzle.

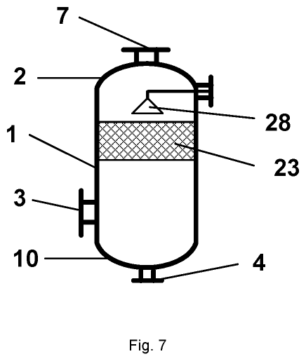

FIG. 7: Droplet separator with demister from the prior art.

### LIST OF REFERENCE NUMBERS USED

1 shell
2 upper hood
3 inlet
4 liquid exit port
5 open apex cone
6 baffle
7 gas exit port
8 drip plate
9 nozzle(s)
10 lower hood
11 vertical longitudinal axis
12 main spraying direction or normal vector of the cross-sectional area
13 direction of gravity, gravity vector
14 vertical section plane
15 nozzle outlet or cross-sectional area of the nozzle through which the liquid flows out of the respective nozzle
16 internal angle
17 insert element
18 lance
19 holding element
20 open elements
23 demister
25 opposite direction to gravity, opposite of gravity vector
26 height of the centrifugal droplet separator
27 diameter of the centrifugal droplet separator
28 spraying device

FIG. 1 is a schematic of one example of an embodiment of a centrifugal drop separator of the invention. Illustrated on the left-hand side is a longitudinal section of the centrifugal droplet sep-arator along its vertical longitudinal axis. Shown on the right-hand side is a cross section at right angles to the direction of gravity 13, from which the arrangement of the nozzles 9 relative to the shell 1 is apparent.

The centrifugal droplet separator is defined by its outer shell 1 of circular cross section, its upper hood 2 that forms the top boundary and has a gas exit port 7 for the gas stream cleaned in the centrifugal droplet separator, its drip plate 8 which is disposed beneath the gas exit port and is intended to catch relatively small liquid droplets, its lower hood 10 that bounds the shell 1 at the bottom and has a liquid exit port 4 for removal of the separated liquid droplets, and by its dimensions such as the height 26 and the diameter 27.

A gas stream laden with liquid droplets is supplied to the centrifugal droplet separator by a tangential inlet 3. This induces a vortex along the shell 1. Under gravity 13, the liquid droplets move downward in the direction of a liquid exit port 4. For more efficient separation of the droplets, an open apex cone 5 with baffles 6 is installed. The cleaned gas stream flows out of the separator via a gas exit port 7.

In the embodiment shown, the stabilizer liquid is sprayed into the interior of the centrifugal droplet separator via six nozzles 9.

The nozzle outlet of the respective nozzle 9 is above the tangential inlet 3 and below the drip plate 8 in the centrifugal droplet separator.

The main spraying direction for each individual nozzle 9 is directed upward at an internal angle 16 in the range from 0 to 60° relative to the vertical longitudinal axis, which means that all walls in the interior of the centrifugal droplet separator are fully wettable.

FIG. 2 shows a main spraying direction 12 of a nozzle 9, which is defined by a normal vector on a cross-sectional area, the nozzle outlet 15. The liquid is sprayed through the nozzle outlet 15 of the nozzle 9.

FIG. 3 shows a section plane 14 for each individual nozzle 9, which comprises a vertical longitudinal axis 11 of the shell 1 and a geometric centroid of the cross-sectional area (nozzle outlet 15 according to FIG. 2) of the nozzle 9. Also shown here are the gravity vector 13, the opposite of the gravity vector 25, and the main spraying direction 12, i.e. the normal vector, of the nozzle 9.

FIG. 4 shows that, in the section plane 14 along the vertical longitudinal axis 11, it is possible to define an internal angle 16 present between the opposite of the gravity vector 25 and the vector of the main spraying direction 12, i.e. the normal vector, of the respective nozzle 9. The two vectors are projected here onto the section plane 14. In this case, the main spraying direction 12 is inclined away from the shell surface 1.

FIG. 5 shows a case in the section plane 14 along the vertical longitudinal axis 11 where the main spraying direction 12, i.e. the normal vector, is inclined toward the shell surface 1. An internal angle 16 is defined between the opposite of the gravity vector 25 and the vector of the main spraying direction 12 of the respective nozzle 9. The two vectors are projected here onto the section plane 14.

FIG. 6 shows a schematic of an insert element 17 for a nozzle 9. A nozzle 9 is fixed here on a lance 18. The lance 18 runs through an opening element 20 in the shell 1, where the opening element 20 is sealed by an openable holding element 19. In this example, the opening element is a port and the openable holding element 19 is a flange.

FIG. 7 shows a droplet separator with demister from the prior art. A gas stream laden with liquid droplets is fed to the separator through an inlet 3 in the shell 1. Under gravity, the liquid droplets move downward in the direction of a liquid exit port 4 disposed in a lower hood 10. The cleaned gas stream flows out of the separator via a gas exit port 7. The gas exit port is disposed here on a lower hood 2. A demister 23 ensures that relatively small liquid droplets are caught. A spraying device 28 wets the demister in order to prevent rapid blockage, resulting from polymerization of liquid droplets.

### EXAMPLES

### Comparative Example 1 for nBA Plant

The substance n-butyl acrylate (nBA) can be produced on an industrial scale by an acid-catalyzed esterification of (meth)acrylic acid with n-butanol. One corresponding process is disclosed in document DE 10063510 A1 (BASF AG). A process step in such processes is the separation of liquid droplets from a gas stream, where the liquid droplets include the phenothiazine (PTZ) component to be separated off.

In comparative example 1 according to the prior art, the droplets were separated off in a continuously operated droplet separator with demister 23 according to FIG. 7.

The droplet separator had a height of 4 m and a diameter of 1.0 m, including neither the gas exit port 7 nor the liquid outlet 4 in the determination of the height. The height of the demister was 1470 mm. The demister used was the “Euroform DV270” demister manufactured by Munters Euroform GmbH (Philipsstrasse 8, 52068 Aachen).

The feed rate was 10 000 kg/h of product. The pressure in the droplet separator was set to 420 mbar above standard pressure. The temperature was 118° C.

The composition of the product fed in via inlet 3 in the droplet separator was:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.68% | by weight |
| phenothiazine | 10 | ppm by weight |
| 4-methoxyphenol | 0 | ppm by weight |
| nitrogen | 0.04% | by weight |

400 kg/h of liquid at a temperature of 34° C. was sprayed via the spraying device 28 onto the top side of the demister 23. The liquid had the following composition:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.72% | by weight |
| phenothiazine | <1 | ppm by weight |
| 4-methoxyphenol | 15 | ppm by weight |

The gas stream of 9657 kg/h exiting from the gas exit port 7 had the following composition:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.68% | by weight |
| phenothiazine | 2 | ppm by weight |
| 4-methoxyphenol | 1 | ppm by weight |
| nitrogen | 0.04% | by weight |

The 743 kg/h of liquid exiting from the liquid exit port 4 had the following composition:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.71% | by weight |
| phenothiazine | 110 | ppm by weight |
| 4-methoxyphenol | 1 | ppm by weight |

After an operating time of 120 days, the droplet separator had to be cleaned owing to soiling. It was found that polymers had formed, which soiled the demister 23 and the inner wall of the droplet separator, and necessitated the shutdown of the entire plant.

### Example 1 for nBA Plant

For inventive example 1, the droplet separator of comparative example 1 was replaced by an inventive centrifugal droplet separator according to FIG. 1.

The dimensions of the centrifugal separator were:
Diameter 27: 1500 mm
Height 26: 3278 mm
Height of the nozzle plane based on the lower hood: 2039 mm
Gas inlet 3: DN500
Gas outlet 7: DN600
Liquid outlet 4: DN150
Distance between nozzle and drip plate 8: 500 mm
Distance between the outer nozzles and the wall of the centrifugal droplet separator: 7.5 mm
Apex cone 5: diameter: 1050 mm, height: 300 mm
Drip plate 8: diameter: 1000 mm, height: 300 mm

In determining the height, neither the gas exit port 7 nor the liquid outlet 4 was taken into account.

Installed in the centrifugal droplet separator were six Lechler 490.404.1Y.CA.00.0 full-cone nozzles according to the following data sheet: “Lechler_Axial-Vollkegeldüsen_490_491.pdf” (https://www.lechler.com/fileadmin/media/kataloge/pdfs/industrie/katalog/DE/03_vollkegel/lechler_vollkegelduesen_baureihe_490_491.pdf). The internal angle of the main spraying direction was 15° and was inclined inward, i.e. directed away from the shell 1.

A stabilizer liquid was metered in continuously through the nozzles directed upward. The total volume flow rate through all nozzles 9 was 200 to 600 l/h.

In this example, the gas exit port 7 was above the shell 1 on the outer face of the shell 1, as a result of which the centrifugal droplet separator provided fewer dead zones.

The feed rate of the gas stream laden with liquid droplets was 10 000 kg/h. The pressure in the centrifugal droplet separator was set to 420 mbar above standard pressure. The temperature was 118° C.

The composition of the product fed in via inlet 3 in the centrifugal droplet separator was:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.68% | by weight |
| phenothiazine | 10 | ppm by weight |
| 4-methoxyphenol | 0 | ppm by weight |
| nitrogen | 0.04% | by weight |

A liquid stream of the stabilizer liquid of 400 kg/h in total at a temperature of 34° C. was sprayed via the nozzles 9 onto the wall of the centrifugal droplet separator. The stabilizer liquid had the following composition:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.72% | by weight |
| phenothiazine | <1 | ppm by weight |
| 4-methoxyphenol | 15 | ppm by weight |

The gas stream of 9657 kg/h exiting from the gas exit port 7 had the following composition:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.68% | by weight |
| phenothiazine | <1 | ppm by weight |
| 4-methoxyphenol | 1 | ppm by weight |
| nitrogen | 0.04% | by weight |

The 743 kg/h of liquid exiting from the liquid exit port 4 had the following composition:

| | | |
|---|---|---|
| n-butanol | 0.04% | by weight |
| n-butyl acetate | 0.07% | by weight |
| di-n-butyl ether | 0.10% | by weight |
| isobutyl acrylate | 0.07% | by weight |
| n-butyl acrylate | 99.71% | by weight |
| phenothiazine | 130 | ppm by weight |
| 4-methoxyphenol | 1 | ppm by weight |

In this example, it was possible to achieve an operating time of more than 180 days without shutdown as a result of soiling in the centrifugal droplet separator. Irreversible coating or deposits of polymer on the centrifugal droplet separator were not observed even after operation for 180 days.

Moreover, the centrifugal droplet separator, by virtue of its efficient deposition, achieved a reduction in the proportion by mass of phenothiazine to below 1 ppm by weight in the target product. The target product here is the gas stream exiting from the centrifugal droplet separator. In the droplet separator with demister according to comparative example 1, phenothiazine was reduced only to 2 ppm by weight.

### Comparative Example 2 for 2-EHA Plant

The substance 2-ethylhexyl acrylate (2-EHA) can be produced on an industrial scale by an acid-catalyzed esterification of (meth)acrylic acid with 2-ethylhexanol. One corresponding process is disclosed in document DE 19604253 A1 (BASF AG). A process step in such processes is the separation of liquid droplets from a gas stream, where the liquid droplets include the phenothiazine (PTZ) component to be separated off.

In comparative example 2 according to the prior art, the droplets were separated off in a continuously operated droplet separator with demister 23 according to FIG. 7.

The droplet separator had a height of 4 m and a diameter of 1.2 m. The height of the demister 23 was 790 mm. The demister used was the “Euroform DV270” demister manufactured by Munters Euroform GmbH (Philipsstrasse 8, 52068 Aachen).

The feed rate was 10 000 kg/h of product. The pressure in the droplet separator was set to 140 mbar above standard pressure and the temperature to 148° C.

The composition of the product fed in via inlet 3 in the droplet separator was:

| | | |
|---|---|---|
| 2-ethylhexanol | 0.08% | by weight |
| n-ethylhexyl acetate | 0.15% | by weight |
| n-diethylhexyl ether | 0.01% | by weight |
| 2-ethylhexyl acrylate | 99.71% | by weight |
| 2-ethylhexyl 3-(2-ethylhexoxy)propionate | 0.03% | by weight |
| phenothiazine | 10 | ppm by weight |
| 4-methoxyphenol | 0 | ppm by weight |
| nitrogen | 0.02% | by weight |

A liquid stream of 490 kg/h at a temperature of 34° C. was sprayed via the spraying device 28 onto the top side of the demister 23. The liquid had the following composition:

| | | |
|---|---|---|
| 2-ethylhexanol | 0.08% | by weight |
| n-ethylhexyl acetate | 0.15% | by weight |
| n-diethylhexyl ether | 0.01% | by weight |
| 2-ethylhexyl acrylate | 99.73% | by weight |
| 2-ethylhexyl 3-(2-ethylhexoxy)propionate | 0.03% | by weight |
| phenothiazine | <1 | ppm by weight |
| 4-methoxyphenol | 15 | ppm by weight |

The gas stream of 9623 kg/h exiting from the gas exit port 7 had the following composition:

| | | |
|---|---|---|
| 2-ethylhexanol | 0.08% | by weight |
| n-ethylhexyl acetate | 0.15% | by weight |
| n-diethylhexyl ether | 0.01% | by weight |
| 2-ethylhexyl acrylate | 99.72% | by weight |
| 2-ethylhexyl 3-(2-ethylhexoxy)propionate | 0.02% | by weight |
| phenothiazine | 4 | ppm by weight |
| 4-methoxyphenol | 1 | ppm by weight |
| nitrogen | 0.02% | by weight |

The 867 kg/h of liquid exiting from the liquid exit port 4 had the following composition:

| | | |
|---|---|---|
| 2-ethylhexanol | 0.03% | by weight |
| n-ethylhexyl acetate | 0.09% | by weight |
| n-diethylhexyl ether | 0.01% | by weight |
| 2-ethylhexyl acrylate | 99.70% | by weight |
| 2-ethylhexyl 3-(2-ethylhexoxy)propionate | 0.16% | by weight |
| phenothiazine | 70 | ppm by weight |
| 4-methoxyphenol | 10 | ppm by weight |

After an operating time of 80 days, the droplet separator had to be cleaned owing to soiling. It was found that polymers had formed, which soiled the demister 23 and the inner wall of the droplet separator, and necessitated the shutdown of the entire plant.

### Example 2 for 2-EHA Plant

For inventive example 2, the droplet separator of comparative example 2 was replaced by an inventive centrifugal droplet separator according to FIG. 1.

The dimensions of the centrifugal separator were:
Diameter 27: 1800 mm
Height 26: 3700 mm
Height of the nozzle plane based on the lower hood: 2370 mm
Gas inlet 3: DN600
Gas outlet 7: DN600
Liquid outlet (4): DN150
Distance between nozzle and drip plate 8: 500 mm
Distance between the outer nozzles and the wall of the centrifugal droplet separator: 7.5 mm
Apex cone 5: diameter: 1260 mm, height: 360 mm
Drip plate 8: diameter: 1200 mm, height: 400 mm

In determining the height, neither the gas exit port 7 nor the liquid outlet 4 was taken into account.

Six nozzles were present in the centrifugal droplet separator. The nozzles were manufactured by Lechler. The nozzle used here was the 490.404.1Y.CA.00.0 full-cone nozzle according to the data sheet “Lechler_Axial-Vollkegeldüsen_490_491.pdf”, which can be retrieved using the link: “https://www.lechler.com/fileadmin/media/kataloge/pdfs/industrie/katalog/DE/03_vollkegel/lechler_vollkegelduesen_baureihe_490_491.pdf”. The internal angle of the main spraying direction was 15° and was inclined inward, i.e. directed away from the shell 1.

In this example, the gas exit port 7 was above the shell 1 on the outer face of the shell 1, as a result of which the centrifugal droplet separator provided fewer dead zones.

The feed rate of the gas stream laden with liquid droplets was 10 000 kg/h. The pressure in the centrifugal droplet separator was set to 140 mbar above standard pressure. The temperature here was 148° C.

The composition of the product fed in via inlet 3 in the centrifugal droplet separator was:

| | | |
|---|---|---|
| 2-ethylhexanol | 0.08% | by weight |
| n-ethylhexyl acetate | 0.15% | by weight |
| n-diethylhexyl ether | 0.01% | by weight |
| 2-ethylhexyl acrylate | 99.71% | by weight |
| 2-ethylhexyl 3-(2-ethylhexoxy)propionate | 0.03% | by weight |
| phenothiazine | 10 | ppm by weight |
| 4-methoxyphenol | 0 | ppm by weight |
| nitrogen | 0.02% | by weight |

A liquid stream of the stabilizer liquid of 490 kg/h at a temperature of 34° C. was sprayed via the nozzles 9 onto the wall of the centrifugal droplet separator. The stabilizer liquid had the following composition:

| | | |
|---|---|---|
| 2-ethylhexanol | 0.08% | by weight |
| n-ethylhexyl acetate | 0.15% | by weight |
| n-diethylhexyl ether | 0.01% | by weight |
| 2-ethylhexyl acrylate | 99.73% | by weight |
| 2-ethylhexyl 3-(2-ethylhexoxy)propionate | 0.03% | by weight |
| phenothiazine | <1 | ppm by weight |
| 4-methoxyphenol | 15 | ppm by weight |

The gas stream of 9623 kg/h that exited from the gas exit port 7 had the following composition:

| | | |
|---|---|---|
| 2-ethylhexanol | 0.08% | by weight |
| n-ethylhexyl acetate | 0.15% | by weight |
| n-diethylhexyl ether | 0.01% | by weight |
| 2-ethylhexyl acrylate | 99.72% | by weight |
| 2-ethylhexyl 3-(2-ethylhexoxy)propionate | 0.02% | by weight |
| phenothiazine | <2 | ppm by weight |
| 4-methoxyphenol | 1 | ppm by weight |
| nitrogen | 0.02% | by weight |

The liquid stream of 867 kg/h exiting from the liquid exit port 4 had the following composition:

| | | |
|---|---|---|
| 2-ethylhexanol | 0.03% | by weight |
| n-ethylhexyl acetate | 0.09% | by weight |
| n-diethylhexyl ether | 0.01% | by weight |
| 2-ethylhexyl acrylate | 99.70% | by weight |
| 2-ethylhexyl 3-(2-ethylhexoxy)propionate | 0.16% | by weight |
| phenothiazine | 100 | ppm by weight |
| 4-methoxyphenol | 10 | ppm by weight |

In this example, it was possible to achieve an operating time of more than 150 days without shutdown as a result of soiling in the centrifugal droplet separator. Irreversible coating or deposits of polymer on the centrifugal droplet separator were not observed even after operation for 150 days.

Moreover, the centrifugal droplet separator, by virtue of its sufficient deposition, achieved a reduction in the proportion by mass of phenothiazine to below 2 ppm by weight in the target product. The target product here is the gas stream exiting from the centrifugal droplet separator. In the droplet separator with demister (comparative example 2), phenothiazine was reduced only to 4 ppm by weight.

1.-14. (canceled)

15. A centrifugal droplet separator for separating liquid droplets out of a gas stream, comprising
a shell having a circular cross section and a vertical longitudinal axis,
an upper hood that bounds the shell at the top and has a gas exit port for the gas stream cleaned in the centrifugal droplet separator,
a drip plate disposed beneath the gas exit port,
a lower hood that bounds the shell at the bottom and has a liquid exit port for removal of the deposited liquid droplets,
and an inlet that opens tangentially into the shell for supply of the gas stream, wherein
there are at least two nozzles for feeding a stabilizer liquid into the interior of the centrifugal droplet separator,
the nozzle outlet of the respective nozzle is above the tangential inlet and below the drip plate in the centrifugal droplet separator,
the main spraying direction for each individual nozzle is directed upward at an internal angle in the range from 0 to 60° relative to the vertical longitudinal axis and hence all walls in the interior of the centrifugal droplet separator are fully wettable.

16. The centrifugal droplet separator according to claim 15, wherein the length ratio between the axial distance of the nozzle outlet of the uppermost nozzle from the drip plate and the height of the centrifugal droplet separator is in the range from 0.03 to 0.15.

17. The centrifugal droplet separator according to claim 15, wherein the length ratio between the radial distance of the nozzle outlet from the inner shell surface and the height of the centrifugal droplet separator is not more than 0.06.

18. The centrifugal droplet separator according to claim 15, wherein the internal angle of the respective nozzle is in the range from 0 to 50°.

19. The centrifugal droplet separator according to claim 15, wherein an open apex cone for stabilization of the gas stream is mounted on baffles in the liquid exit port.

20. The centrifugal droplet separator according to claim 15, wherein the gas exit port in the centrifugal droplet separator is at least partly above the shell on the side of the outer face of the shell.

21. The centrifugal droplet separator according to claim 15, wherein the lower half of the centrifugal droplet separator has a temperature control unit, especially a heater, on the outside of the shell.

22. The centrifugal droplet separator according to claim 15, wherein the nozzles are fixed in the centrifugal droplet separator by at least one insert element, where the respective insert element has a lance and at least one holding element for at least one nozzle.

23. The centrifugal droplet separator according to claim 15, wherein at least one nozzle in each case runs through an opening element in the shell, where the opening element is sealed by an openable holding element.

24. A method of separating liquid droplets out of a gas stream in a centrifugal droplet separator comprising a shell having a circular cross section and a vertical longitudinal axis, an upper hood that bounds the shell at the top and has a gas exit port for the gas stream cleaned in the centrifugal droplet separator, a drip plate disposed beneath the gas exit port,
a lower hood that bounds the shell at the bottom and has a liquid exit port for removal of the deposited liquid droplets, and an inlet that opens tangentially into the shell, through which the gas stream is fed in, wherein
a stabilizer liquid is fed into the interior of the centrifugal droplet separator through at least two nozzles, the nozzle outlet of the respective nozzle is above the tangential inlet and below the drip plate in the centrifugal droplet separator, the main spraying direction of the respective nozzle is directed upward at an internal angle in the range from 0 to 60° relative to the vertical longitudinal axis, and hence all walls in the interior of the centrifugal droplet separator are fully wetted by the stabilizer liquid.

25. The method according to claim 24, wherein the stabilizer liquid is fed continuously to the centrifugal droplet separator.

26. The method according to claim 24, wherein the stabilizer liquid comprises 4-methoxyphenol (MeHQ).

27. The method according to claim 24, wherein the gas stream fed to the centrifugal droplet separator comprises droplets of substances which, because of their chemical properties, may polymerize on walls of the centrifugal droplet separator.

28. The method according to claim 27, wherein the gas stream fed to the centrifugal droplet separator comprises acrylates that have formed as a result of an acid-catalyzed esterification of (meth)acrylic acid with C4 to C10 alcohols, especially n-butyl acrylate (nBA) or 2-ethylhexyl acrylate (2-EHA).
